(19) United States
(12) Patent Application Publication
(10) Pub. No.: US 2012/0286739 A1
(43) Pub. Date: Nov. 15, 2012

(54) System and Method for Estimating a State of a Battery Pack

(75) Inventors: Gary R. O'Brien, JR., Riverview, MI (US); Brian D. Rutkowski, Ypsilanti, MI (US); Shazad M. Butt, Troy, MI (US)

(73) Assignee: A123 SYSTEMS, INC., Waltham, MA (US)

(21) Appl. No.: 13/514,711

(22) PCT Filed: Dec. 13, 2010
(86) PCT No.: PCT/US10/60112

§ 371 Date: Jun. 8, 2012

Related U.S. Application Data
(60) Provisional application No. 61/285,652, filed on Dec. 11, 2009.

(51) Int. Cl. H02J 7/00; H01M 10/48; H01M 10/44; G01N 3/08

(52) U.S. Cl. 320/134; 73/818; 429/91; 429/50

(57) ABSTRACT

A method for estimating the state of a battery having multiple cells is disclosed. In one embodiment, strain gauges are coupled to battery binding bands that hold cells of the battery together. The strain measured by the gauges may be related to the electrical charge stored by the battery. The method may improve estimates of battery state of charge during conditions when battery voltage changes little and the battery continues to accept charge.

### CROSS REFERENCE TO RELATED APPLICATIONS

This application claims priority from U.S. Provisional Patent Application Ser. No. 61/285,652, filed Dec. 11, 2009 and entitled SYSTEM AND METHOD FOR ESTIMATING A STATE OF A BATTERY PACK, the entirety of which is hereby incorporated herein by reference for all intents and purposes.

### TECHNICAL FIELD

The present application relates to estimating a state of a rechargeable battery.

### BACKGROUND AND SUMMARY

Lithium-ion batteries are being quickly accepted as reliable high density power storage devices. However, lithium-ion batteries have different charging characteristics than other battery technologies such as nickel-cadmium (NiCd) and nickel-metal-hydride (NiMH). For example, a typical cell of a NiMH battery outputs 1.2 volts whereas lithium-ion batteries typically output 3.4 volts or more. In U.S. Pat. No. 7,602,146, a system is described that appears to prevent overcharging of certain cells of a battery pack. One part of the described system uses a circuit to detect a parameter of a battery cell to prevent operation of a powered device when a battery cell is overcharged. Another part of the system prevents overcharging of battery cells and the operation of powered devices by recognizing that lithium-ion battery cells can expand when charged. In particular, the system severs connections between battery cells that are designed to disconnect when an overcharged battery cell expands and mechanically breaks an electrical connection. In another embodiment, a battery circuit may is mechanically broken by a plunger that severs the circuit using the force from an expanding battery cell.

However, under some conditions, it may be difficult to determine the state of charge of a battery from a single parameter such as voltage because some lithium-ion compounds can continue to accept charge with little change in voltage. Further, a system that may not be able to estimate an accurate state of battery charge and that relies on a mechanical disconnect of battery cells may be useful for hand tools, but such a system may be less desirable for applications where users have an expectation of continued operation. For example, if a group of battery cells are assembled into a battery pack and used to power a vehicle, a driver may become frustrated if performance of his or her vehicle degrades in response to a single battery cell that charges beyond a desired amount.

The inventors herein have developed a method for estimating a state of a battery pack. In particular, the inventors have developed a method for a battery pack including a plurality of battery cells bound together, comprising: generating compression of the plurality of battery cells; and estimating a state of the plurality of battery cells in response to an indication of the compression. The compression indication may be a tensile force of a binding band or other structure holding the cells together, a compression force generated within the cell stack by the binding band or other holding structure, or various others as described herein.

By measuring the compression of a group of battery cells, such as via a strain gauge on a binding band, it may be possible to determine the state of a battery. For example, battery cells may expand and contract as the amount of stored charge varies, thus changing the amount of compression of the cells. Thus, when the battery cells are constrained via a restraining device (such as a binding band), while being charged, the batteries may exert a force on the restraining device. The force exerted on the restraining device increases proportionally with increasing charge. As a result, the state of battery charge, for example, may be inferred by measuring the change in force or strain acting on the restraining device. Such a method for estimating state of charge may be particularly useful for battery compounds that increase little in voltage output but continue to store charge. Further, the determined battery state may then be used to control battery operation and/or other related system operation, such as a related vehicle system.

The present description may provide several advantages. In particular, the approach may provide an improved estimate of the state of battery charge. In addition, the method may reduce the need for battery protection options that result in deactivation of the entire battery. Further, the present method may be less expensive than other methods for determining battery state.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of a battery control system;

FIG. 2 shows a schematic view of an exemplary assembly of a battery cell stack;

FIG. 3 shows a schematic view of an exemplary battery cell;

FIG. 4A shows a schematic view of one embodiment of a strain gauge coupled to a binding band;

FIG. 4B shows a schematic view of another embodiment of a strain gauge coupled to a binding band;

FIG. 5 shows cell voltage versus cell charge and cell strain versus cell charge;

FIG. 6 shows a non-limiting application of the present system and method;

FIG. 7 is a flow chart for a method to determine the state of a battery pack in response to a strain gauge;

FIG. 8A shows a plot of battery cell charge capacity loss verses the square root of time;

FIG. 8B shows a plot of battery cell charge capacity loss verses battery charging cycles in amp hours;

FIG. 9A shows a plot of battery cell stack binding belt strain verses battery cell charge capacity loss;

FIG. 9B shows a plot that shows a trend of battery cell charge capacity loss and change in battery cell stack binding belt strain; and

FIG. 10 is a flow chart of a method for determining battery state of health from battery cell stack binding belt strain.

### DETAILED DESCRIPTION OF THE DEPICTED EMBODIMENTS

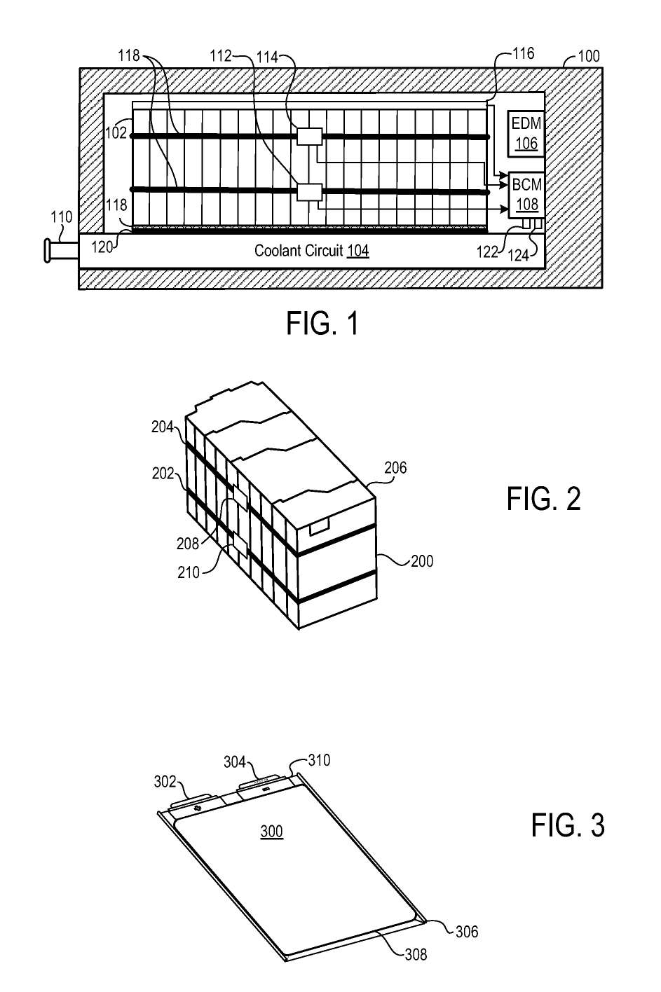

The present description is related to controlling the state of a battery pack. In one embodiment, the battery pack may be designed to include an enclosure and structure as is illustrated in FIG. 1. The battery pack may be comprised or one or more battery cell stacks, one of which is illustrated in FIG. 2. The battery cell stacks are comprised of a plurality of battery cells, one of which is illustrated in FIG. 3.

The state of the battery pack may be estimated and reported by a battery control module (BCM). The BCM performs a variety of functions, such as communications with systems external to the battery pack, management of other modules that are integrated into the battery pack, battery pack charging and discharging, battery enclosure humidity control, managing battery control modes (e.g., sleep and operate), and sensor signal conditioning and processing. The BCM estimates battery states via inputs and outputs, one or more of such outputs being a strain gauge coupled to battery cell binding band. The strain gauge provides battery cell binding band strain data, which may correlate with battery cell stack state of charge. If the strain gauge indicates that a battery cell stack is charged above a predetermined amount, the BCM may discharge a portion of the battery cell stack to a resistive load to return the cell stack to a predetermined charge.

Referring now to FIG. 1, battery pack 100 includes battery cell stack 102, coolant circuit 104, electrical distribution module (EDM) 106, and BCM 108. Coolant enters the coolant circuit at coolant connector 110. Coolant circuit 104 is in thermal communication with battery cell stack 102 via conductive grease 118 and a cold plate 120. When heat is generated by cell stack 102, coolant circuit 104 transfers the heat to a location outside of battery pack 100. In one embodiment, coolant circuit 104 may be in communication with a vehicle radiator, when the battery pack is coupled in a vehicle.

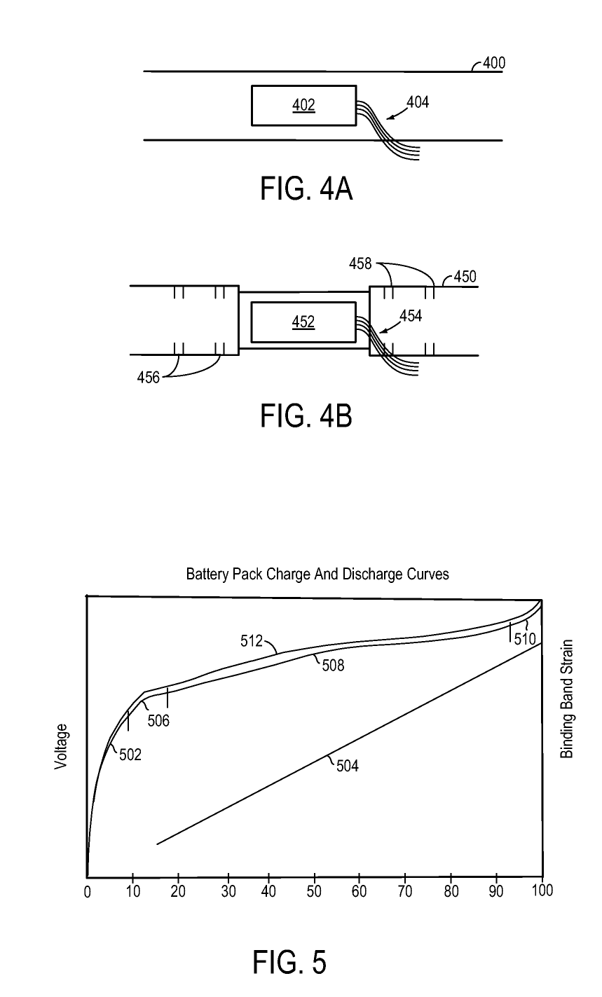

Battery cell stack 102 is bound by plastic or metal binding bands 118. The binding bands may be under tension when assembled with the battery cell stack. Strain gauges 112 and 114 are coupled to binding bands 118, additional details of which are described in FIGS. 4A-4B. The strain gauges are responsive to changes in the compressive forces generated by expansion and/or contraction of the battery cells as the state of charge of the pack varies. Voltage of battery cells in battery cell stack 102 is monitored and balanced by monitor and balance board (MBB) 116, which may include a plurality of current, voltage, and other sensors. EDM 106 controls the distribution of power from the battery pack to the load. The BCM 108 controls ancillary modules such as the EDM and cell MBB. The BCM may be comprised of a microprocessor having random access memory, read only memory, input ports, real time clock, and output ports. Humidity sensor 122 and temperature sensor 124 provide internal environmental conditions of battery pack 100 to BCM 108.

Referring now to FIG. 2, an exemplary assembly of a battery stack is shown. Battery pack 200 is comprised of a plurality of battery cells. The battery cells are strapped together by binding bands 202 and 204. The binding bands are shown wrapped around the battery stack, but binding bands may simply have a length from the bottom of the battery cell stack to the top of the battery cell stack. In other words, the bindings may attach to the top and bottom covers of the battery cell stack. In other embodiments, the binding bands may be comprised of threaded studs (e.g., metal threaded studs) that are bolted at the ends. Further, various other approaches may be used to bind the cells together into the stack. For example, threaded rods connected to end plates may be used to provide the desired compression, and in this case the strain gauges may be mounted on, or coupled to, the rods. In another example, the cells may be stacked in a rigid frame with a plate on one end that could slide back and forth against the cells to provide the desired compressive force. In this example, a force sensor may be coupled to the plate to determine the compressive force. Further, the force sensor may generate a signal based on the distance measurement of a spring in compression which would be proportional to force.

As such, however generated, the method described herein includes compressing the plurality of battery cells and then using a sensor that provides an indication, directly or indirectly, of the changes in compressive force on the stack of cells in the battery pack to estimate, or improve an estimate of, a state (e.g., state of charge) of the battery back.

In one example, strain gauges 208 and 210 are coupled to battery cell stack binding bands 202 and 204. Strain gauges 208 and 210 may be coupled to battery cell stack binding bands 202 and 204 in locations different than those shown in FIG. 2. As such, the location of strain gauges 208 and 210 is non-limiting. Thus, a first strain gauge may be coupled to a first binding band of a battery pack and a second strain gauge coupled to a second binding band, the binding bands wrapped around a plurality of battery cells.

In yet other embodiments, rods held in place by cotter pins may be used to secure the battery cells in place. Thus, it should be understood that various binding mechanisms may be used to hold the cell stack together, and the application is not limited to metal or plastic bands. Cover 206 provides protection for battery bus bars (not shown) that route charge from the plurality of battery cells to output terminals of a battery pack.

FIG. 3 shows an exemplary embodiment of a battery cell. Battery cell 300 includes cathode 302 and anode 304 for connecting to a bus (not shown). The bus routes charge from a plurality of battery plates to output terminals of a battery pack and is coupled to bus bar support 310. Battery cell 300 further includes prismatic cell 308 that contains electrolytic compounds. Prismatic cell 308 is in communication with heat sink 306. Heat sink 306 may be formed of a metal plate with the edges bent up 90 degrees on one or more sides to form a flanged edge. In the example of FIG. 3, the bottom edge, and sides, each include a flanged edge.

When a plurality of cells is put into a stack, the Prismatic cells are separated by a compliant pad (not shown). Thus, a battery cell stack is built in the order of heat sink, Prismatic cell, compliant pad, Prismatic cell, heat sink, and so on. One side of the heat sinks (e.g., flanged edges) may then contact the cold plate to improve heat transfer.

Referring now to FIG. 4A, a schematic view of a strain gauge coupled to a binding band is shown. Binding band 400 may be of metal construction. In this example, strain gauge 402 is coupled to binding band 400 by an adhesive. Strain gauge 402 is powered by and outputs a signal representative of force applied to binding band 400 via electrical conductors 404. In one embodiment, the binding band strain gauge outputs are directed to the BCM for processing. During battery pack assembly, binding band 400 is tightened to a predetermined tension to retain the battery cell stack. Tension in binding band 400 increases when charge is applied to the battery pack cells. As a result, the output of the strain gauge changes in proportion to the change in force applied to the binding band.

Referring now to FIG. 4B, a schematic view of an alternate embodiment of a strain gauged coupled to a binding band is shown. Binding band 450 may be comprised of plastic. Strain gauge 452 is coupled to binding band 450 by way of crimp connections 456 and 458. When tension is applied to binding band 450, strain gauge 452 is exposed to the same tension as binding band 450. Strain gauge 452 is powered by and outputs a signal representative of force applied to binding band 450 via electrical conductors 454.

It should be noted that FIGS. 4A and 4B are merely two examples of how a strain gauge may be coupled to a binding band and are not meant to limit the scope or breadth of the description. Other strain gauge mounting techniques are also anticipated although they may not be expressly shown or mentioned. For example, coupling methods include screwing into the binding bands, gluing, riveting, welding, or soldering the strain gauge to the binding bands.

Referring now to FIG. 5, a plot of simulated cell voltage versus cell charge and simulated cell strain versus cell charge is shown. The left Y-axis represents battery cell stack voltage and The X-axis represents percent state of charge from 0 to 100. The right Y-axis represents binding band strain. Curve segments 502, 506, 508, and 510 represent battery cell voltage versus battery cell charge during a battery cell discharge sequence. Curve 512 represents battery cell voltage versus battery cell charge during a battery cell charge sequence. Curve 504 represents binding band strain verses percent state of battery charge.

Notice that at curve segment 502, battery cell voltage increases at a high rate as percent state of charge increases. In this region, battery cell voltage provides a high resolution estimate of battery cell state of charge. At curve segment 506, battery cell voltage rate of change begins to decrease as percent state of charge continues to increase. In this region, battery cell voltage still provides for a good estimate of battery state of charge, albeit with less resolution than segment 502. At curve segment 508, battery cell voltage rate of change further decreases as percent state of charge continues to increase. In this region, battery cell voltage provides a lower resolution estimate of battery state of charge. At curve segment 510, battery cell voltage rate of change begins to increase as percent state of charge approaches 100 percent. In this region, resolution of state of charge increases, and battery cell voltage provides a better estimate of battery cell state of charge than segment 508, for example.

Curve 504 represents a cell voltage versus binding band tension. Notice that there is a linear relationship between binding band strain and percent battery state of charge. However, for battery state of charge less than 10 percent, there is insufficient information from the binding band strain to determine battery state of charge. Thus, battery cell state of charge may be estimated using either battery voltage or binding band strain, or combinations thereof. In one embodiment, battery state of charge may be estimated from both battery cell voltage and binding band strain. For example, when battery cell voltage is low, battery cell state of charge may be estimated from voltage curve segments 502 and 506. As battery voltage increases, battery state of charge may be estimated from binding band strain curve 504. In this way, battery cell voltage and binding band strain may be used together to estimate battery cell state of charge.

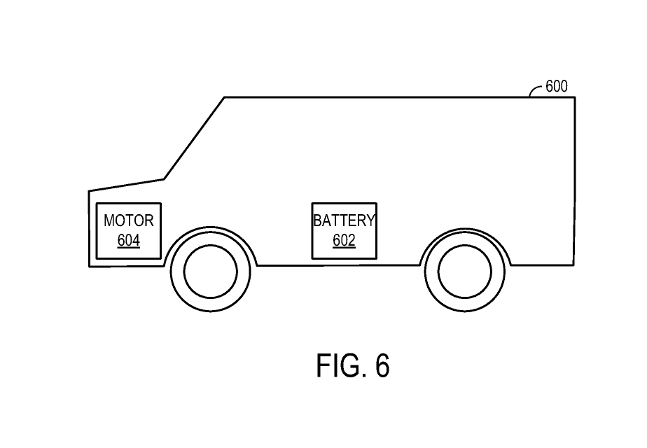

Referring now to FIG. 6, a schematic view of a non-limiting application of the present system and method is shown. In particular, battery pack 602 is installed in a vehicle 600 for the purpose of supplying energy to propel vehicle 600 by way of electric motor 604. In one embodiment, vehicle 600 may be propelled solely by electric motor 604. In another embodiment, vehicle 600 may be a hybrid vehicle that may be propelled by an electric motor and an internal combustion engine.

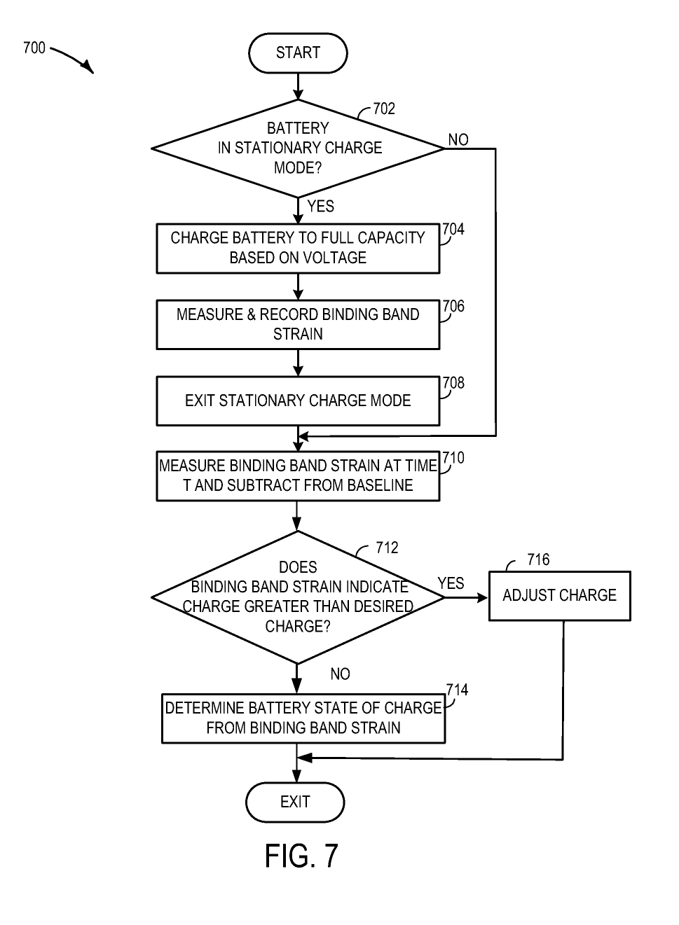

Referring now to FIG. 7, a flow chart for a method to determine the state of a battery pack in response to a strain gauge is shown. The flow chart may represent code or instructions programmed into computer readable storage medium, such as in the BCM. At 702, routine 700 judges whether or not the battery pack is in a stationary charge mode. A stationary charge mode may be entered when the battery is connected to a stationary charging station. For example, when a driver parks his or her vehicle for the evening and plugs the vehicle into the utility power grid. In one embodiment, stationary charging mode can be differentiated from other charging modes in that the BCM controls the rate of battery cell charging and monitors current supplied to the battery cells as well as the battery cell voltages. In other operating modes, an external controller may control the rate of battery cell charge and discharge in response to information from the BCM and in response to other variables such as driving conditions, for example. If routine 700 judges that the battery is in a stationary charging mode, routine 700 proceeds to 704. Otherwise, routine 700 proceeds to 710.

At 704, the battery is charged to full capacity based on the monitored voltages of battery cells. While in the stationary charge mode, the BCM has control over the rate of cell charging and can monitor the voltage of individual battery cells as well as the voltage of the entire battery pack. Thus, by combining other sources of data (e.g., charging current) with measured battery voltage is possible to accurately estimate when the battery cells are fully charged. After the battery cells are fully charged routine 700 proceeds to 706.

At 706, routine 700 measures and records binding band strain on the battery cell stack. In particular, a voltage or current is applied to strain gauges that are coupled to binding bands that hold the battery cell stacks together. As tension is applied to the binding bands, whether during the initial assembly process or when charge is applied to battery cells, piezoresistive material in the strain gauges changes the output of the strain gauges. It should be noted that more than one battery cell stack may be housed in a battery enclosure. In such applications, the total battery charge may be estimated by the sum of the charge of individual battery cell stacks as determined by strain gauges mounted to the individual battery cell stacks. Further, more than a single strain gauge may be applied to a single stack of battery cells to determine the state of charge of the stack. In one example, the output of two strain gauges may be averaged to determine the state of charge of a battery cell stack.

The amount of strain on all battery cell stacks in the battery enclosure is stored in memory and saved for use when the battery is operated in a non-stationary charging mode. In one embodiment, an array is created in the BCM memory that contains the amount of strain applied to each binding band strain gauge while the battery is fully charged in the stationary charging mode. These stored strain amounts may be considered to be a baseline or zero for each strain gauge. After storing the strain gauge baseline amounts routine, 700 proceeds to 708 where the stationary charge mode is exited.

At 710, the battery is in a non-stationary charging and discharging mode. In this mode, the battery cells may be charged and discharged in response to conditions outside of the battery enclosure rather than by the BCM. For example, in one application, the battery may be charged when a vehicle is decelerating and may be discharged when the vehicle is accelerating. The rate of charging and discharging may be related to conditions such as operator torque demand and state of an internal combustion engine, for example. In a non-stationary charging mode, it may be desirable to estimate battery state of charge based on battery binding band strain because it may be more difficult to get an accurate battery state of charge estimate when the BCM has less control over battery charging.

Returning now to 710, the non-stationary mode battery binding band strain at time T is subtracted from the binding band strain measured and recorded during stationary charge mode. By subtracting the present non-stationary binding band strain from the binding band strain when the battery cells were fully charged, routine 700 may determine if battery cells are charged above a desired amount.

At 712, routine 700 judges whether or not binding band strain indicates battery cell charge is greater than a desired state of battery cell charge. If battery binding band strain is greater in non-stationary charging and discharging mode than in stationary charging mode, the battery state of charge may be deemed higher than desired and routine 700 proceeds to 716. Otherwise, routine 700 proceeds to 714.

At 716, routine 700 adjusts battery charge. In one embodiment, battery charge may be reduced by discharging a portion of battery charge to a passive resistor array. In another example, battery charging may cease until a battery load consumes a portion of the battery charge. In yet another embodiment, the amount of current available to charge the battery may be reduced when the battery binding band strain gauge estimate of battery state of charge exceeds a threshold. Thus, the state of charge of a battery pack may be controlled by sensing a voltage of a plurality of battery cells to determine a battery state of charge. The voltage output from the battery cells may be compared (e.g., by subtracting battery charge inferred from cell voltages from battery charge inferred from strain gauge output) to output of a strain gauge to produce an error signal. And, the error signal may be used for regulating charging and discharging of a plurality of battery cells in response to the comparison. Further, the battery cell charge may be regulated by increasing or reducing an amount of current supplied to charge said plurality of battery cells. As such, voltage of a plurality of battery cells can be adjusted when an estimate of battery state of charge based on said strain gauge disagrees with a battery state of charge estimate based on a voltage measurement of said plurality of battery cells by a threshold amount. After the battery charge is adjusted, routine 700 proceeds to exit.

At 714, routine 700 determines the battery state of charge from the battery binding bands. As discussed above, it may be more difficult to ascertain an accurate estimate of battery state of charge in a non-stationary charging or discharging mode. Consequently, in a non-stationary charging mode, battery state of charge may be estimated by battery voltage, battery cell binding band strain, or by a combination of battery voltage and battery cell binding band strain.

In one example, when battery voltage is in the region of curve 502 of FIG. 5, battery voltage is used to estimate the state of battery charge. In particular, a function that relates battery voltage to battery state of charge is indexed by battery voltage and battery state of charge is output. As discussed above, a plurality of battery cell voltages from individual battery cells may be monitored to determine the voltage of the complete battery pack.

In the same example, when battery voltage is in the range or region of curve 506 of FIG. 5, battery voltage and battery binding band strain may be used to determine battery state of charge. In particular, an estimate of battery state of charge can be made from battery voltage by looking up the battery state of charge from a function as is described above. Similarly, an estimate of battery state of charge may be made from battery binding band strain. The binding band strain may be used to index a function that relates binding band strain to battery cell state of charge. The battery state of charge estimate from the binding bands can be combined with the battery state of charge from battery voltage to determine a final battery state of charge. In this example, the battery state of charge from the binding band strain may be weighed along with the battery voltage state of charge estimate. For example, voltage based battery state of charge may be multiplied by 0.6 and added to binding band based battery state of charge, after binding band based battery state of charge is multiplied by 0.4. In this way, a battery state of charge may be estimated based on sixty percent of the voltage based battery state of charge and forty percent of the binding band based battery state of charge.

If battery voltage is in range or region 508 of FIG. 5 during non-stationary charging and discharging, battery state of charge may be determined solely form battery binding band strain gauges. In this region, the binding band strain gauges may provide a higher resolution estimate of battery state of charge. As such, the battery state of charge may be estimated solely from the battery binding band strain gauges.

If battery voltage is in range or region 510 of FIG. 5 during non-stationary charging and discharging mode, battery state of charge may be determined by taking the higher estimate of battery charge as determined from battery binding strain gauges or from battery voltage. The higher estimate may be taken so that battery cell voltage can be controlled to the lesser estimate of full charge.

It should be noted that in some embodiments the battery binding strain gauge estimate of battery state of charge may be compared to the voltage based estimate of battery state of charge. If there is a difference between the two estimates that exceeds a threshold amount, the battery pack may be charged or discharged to a level where one of the estimates can be verified or dismissed. For example, if state of charge is determined to be X from strain gauge data at the same time state of charge is determined to by Y from battery voltage data, the battery state of charge can be lowered a predicted amount by discharging a current from the battery. If the strain gauge based battery state of charge estimate or voltage based battery state of charge estimate does not follow a predicted reduction in state of charge based on the integrated current output, then it may be determined that the method of determining battery state of charge that does not follow the predicted reduction in state of charge is less reliable than other methods.

In addition, under some conditions it may be desirable to only compare the battery binding strain gauge estimate of battery state of charge and the voltage based estimate of battery state of charge during transient conditions. For example, the strain gauge estimate of battery state of charge may be compared to the voltage based estimate of battery state of charge if the battery is being charged or discharged at a rate above a threshold amount.

In another embodiment, if the battery has not been charged or discharged for a predetermined period of time, the battery state of charge may be updated when the battery exits a sleep mode, from a vehicle key-on condition for example, by a weighted sum of the battery binding band strain gauge battery state of charge based estimate and the voltage based battery state of charge estimate.

In this way, the state of a plurality of battery cells may be estimated in response to a strain gauge, the strain gauge coupled to binding bands holding the battery cells in a group. Further, by sensing voltage of a plurality of battery cells, the sensed voltage can be compared to the output of a strain gauge and the state of charge of the battery can be regulated in response to the comparison.

It should also be noted that different calculations and estimates may use different estimates of battery state of charge. For example, a safety system may solely use battery binding strain gauge estimates of battery state of charge whereas a battery cell balancing routine may solely use a voltage based battery state of charge estimate. Thus, it is possible for voltage based battery state of charge and battery binding band based battery state of charge estimates to be used simultaneously by different battery systems, if desired.

In addition to providing data for determining battery state of charge, battery binding strain gauges may be used to determine battery state of health. Battery state of health refers to the present charging capacity of a battery relative to the charging capacity of the battery when the battery was first manufactured or its rated charge capacity. As batteries cells age and begin to degrade they may have less capacity to store charge. In addition, the volume of the battery cell increases due in part to repeated charging and discharging. By characterizing battery cell growth via battery cell stack binding belts, it may be possible to determine battery state of health.

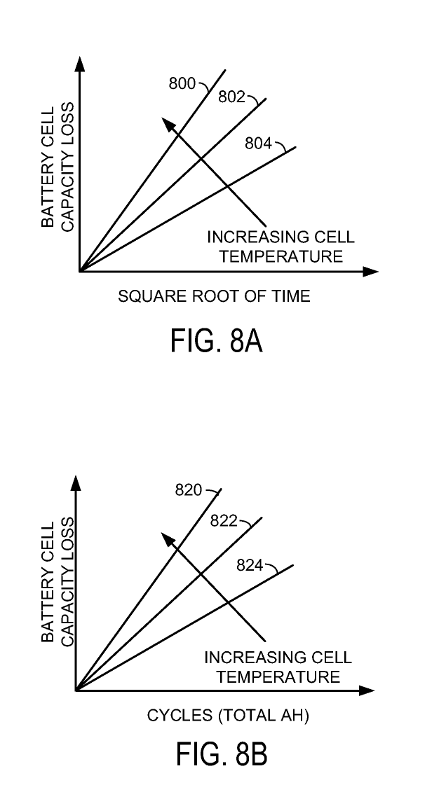

The curves of FIG. 8A, 8B, 9A, and 9B are not actual data. The curves are provided to show directional trends in battery cell charge capacity, battery cell stack binding belt strain, and battery cell charge capacity losses. Actual curves may be empirically determined by way of known methods of battery degradation testing and data regression.

Referring now to FIG. 8A, a plot of battery cell charge capacity loss verses the square root of time is shown. The Y-axis represents battery cell charge capacity losses, and losses increase from the bottom of the plot to the top of the plot. The X-axis represents the square root of time, and the square root of time increases from the left of the plot to the right of the plot. The directional arrow indicates the data trend when battery cell temperature is increased.

Curves 800, 802, and 804 show trends for battery cell charge capacity loss for increasing amounts of time. Specifically, curve 800 indicates that battery cell charge capacity losses are higher when battery cell temperature is higher. Curves 802 and 804 indicate that battery cell charge capacity is reduced over time when battery cell temperature is lower.

Referring now to FIG. 8B, a plot of battery cell charge capacity loss verses battery charging cycles in amp hours is shown. The Y-axis represents battery cell charge capacity losses, and losses increase from the bottom of the plot to the top of the plot. The X-axis represents battery charging cycles, and the number of charging cycles increase from the left of the plot to the right of the plot. The directional arrow indicates the data trend when battery cell temperature is increased.

Curves 820, 822, and 824 show trends for battery cell charge capacity loss for an increasing number of battery charging cycles. In particular, curve 820 indicates that battery cell charge capacity losses are higher when battery cell temperature is higher. Curves 822 and 824 indicate that battery cell charge capacity is reduced over a number of battery charging cycles when battery cell temperature is lower.

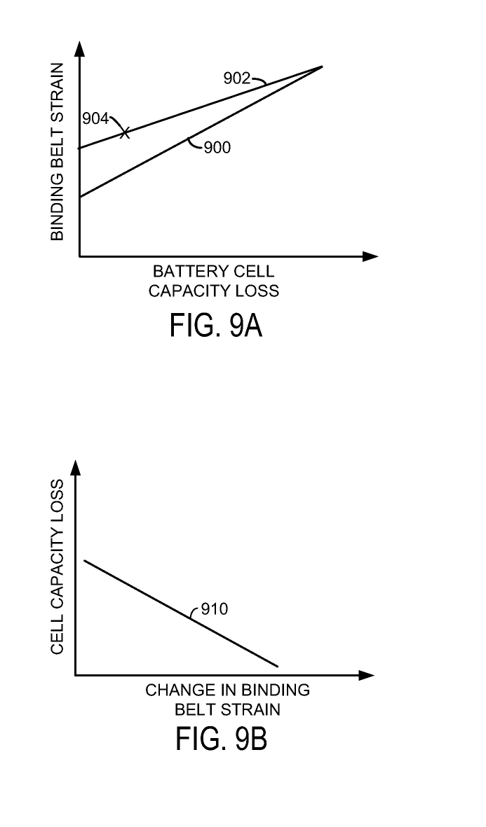

Referring now to FIG. 9A, a plot of battery cell stack binding belt strain verses battery cell charge capacity loss is shown. The Y-axis represents battery cell stack binding belt strain, and increases from the bottom to the top of the plot. The X-axis represents battery cell charge capacity loss, and increases from the left to the right of the plot. Curve 902 represents battery cell stack binding belt strain when a battery cell stack is fully charged and may be referred to as the full charge curve. The point where curve 902 intersects the Y-axis represents when the battery is first manufactured and is capable of storing a rated amount of charge. As the battery ages and is exposed to charge cycling its cell charge capacity loss increases. This trend in indicated by the full charge curve trending up and to the right.

Curve 900 represents the battery cell stack binding belt strain when a battery is substantially without charge (e.g., charge of less than 5% or rated charge) and may be referred to as the zero charge curve. The point where curve 900 intersects the Y-axis represents the strain on the battery binding bands when the battery is first manufactured and without charge. As previously discussed, the volume of a battery cell may increase as the cell ages. Therefore, the stress placed on battery cell stack binding belts increases as battery cells age and as the battery cells are exposed to repeated charging cycles. At the end of battery cell life, the cell volume is at its greatest when charge is not applied to the cell as compared to a new cell when charge is not applied to the new cell. Further, at the end of battery life, the battery cell charge storing capacity approaches zero. Thus, as the performance of a battery cell degrades, the zero charge curve approaches the full charge curve.

The distance between the zero charge curve and the full charge curve indicates the battery charge capacity. For example, at 904 the battery cell stack has been in service for some time and has been exposed to repeated charge cycling. As such, the battery cell stack binding belt strain at full charge has increased as has the battery cell stack binding belt strain at zero charge. Further, if the vertical distance between the full charge curve and the zero charge curve is measured at 904, it can be determined that cell charge capacity has decreased since time of manufacture (e.g., the Y-axis intercept). In one embodiment, the zero charge curve and the full charge curve of representative battery cell packs can be stored in memory and may be used for comparison with present battery cell operating conditions.

As discussed above, battery charge can be related to battery cell stack binding belt strain and battery cell stack binding belt strain at full battery charge capacity can be determined by measuring battery voltages when charging current to the battery cells can be controlled (e.g., during stationary charging mode). Thus, it may be possible to compare present battery cell full charge binding belt strain against known battery degradation data stored in memory to determine battery cell capacity loss and make an assessment of battery state of health. For example, if it is determined that the battery binding band strain between the full charge curve and the zero charge curve has been reduced by 10%, then the battery state of health is at 90%.

In addition, the battery life may be predicted from the battery cell charge capacity loss, real time clock, battery cell temperature history, and a charge cycle counter. For example, battery cell operating temperature, battery cell charge capacity losses, and time functions may be determined from stored temperature data, real time clock history stored in memory (e.g., battery operating hours), and from calculating battery cell charge capacity loss from the relationships described between curves 900 and 902 of FIG. 9A. Note charge capacity loss may be determined by taking the difference between full charge and zero charge battery belt strain at zero battery cell charge capacity loss (e.g., curve 902 minus curve 900 at the Y-axis of FIG. 9A) minus the difference between full charge and zero charge battery belt strain at the present time (e.g., curve 902 minus curve 900 at the time of 904 of FIG. 9A). The known present loss of battery cell charge capacity, the time history, the battery temperature history, and the charging cycle history can be used to index tables or functions that represent the data of FIGS. 8A and 8B. By indexing the known battery charge capacity loss functions it may be possible to determine the present battery cell charge capacity loss trajectory (e.g., the curve stored in memory that matches most closely with the present battery cell losses based on history of battery use). Then the difference between the present time and the expected battery life duration on the present battery cell charge capacity loss trajectory can be determined and presented as the predicted battery life. Likewise, the difference between the present number of battery charge cycles and the expected number of battery charge cycles on the present battery cell charge capacity loss trajectory can be determined and be used to adjust the predicted battery life. For example, if the predicted battery life is one year but the battery is being cycled at a rate that is 10% higher than expected, then the battery life may be reduced accordingly.

Referring now to FIG. 9B, a plot that shows a trend of battery cell charge capacity loss and change in battery cell stack binding belt strain is shown. The Y-axis represents battery cell charge capacity loss, and increases from the bottom to the top of the plot. The X-axis represents battery cell stack binding belt strain, and increases from the left to the right of the plot. Curve 910 shows that battery cell charge capacity loss is highest when change in battery cell stack binding belt strain is least. This indicates that the battery cell has a higher volume and little capacity to store charge near the end of the battery life cycle. As the battery cell charge capacity loss decreases the change in battery cell stack binding belt strain increases. This indicates that the battery cell has a lower volume and higher capacity to store charge when the battery is newly manufactured. Thus, the change in battery cell stack binding belt strain may also be used as an indication of battery state of health.

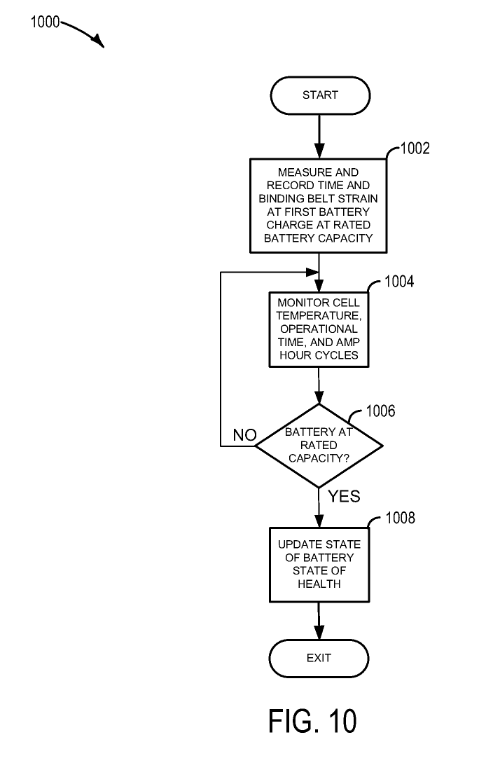

Referring now to FIG. 10, a flow chart of a method for determining battery state of health from battery cell stack binding belt strain is shown. At 1002, routine 1000 measures and records the time and battery cell stack binding belt strain at the first battery charge that is at battery rated charge. The battery may be charged to rated capacity at the time it is installed in an application or at the time of manufacture.

At 1004, routine 1000 monitors battery cell temperature, battery cell stack binding belt strain, operation time, and amp hour cycles. In one embodiment, the battery control module periodically stores battery cell temperature, operation time, battery cell stack binding belt strain, and amp hours.

At 1006, routine 1000 judges whether or not the battery is at a rated charge capacity. In one embodiment, routine 1000 may only judge in the affirmative when a battery is at rated charge capacity when the battery is in a stationary charging mode. If routine 1000 judges that the battery is at a rated charge capacity routine 1000 proceeds to 1008. Otherwise, routine 1000 returns to 1004.

At 1008, routine 1000 updates the battery state of health based on data observed when the battery was charged to rated capacity. In one embodiment, routine 1000 compares battery cell stack binding belt strain to data stored in memory, the data in memory similar to that of FIG. 9A. Next, as described above, the present battery charge capacity is determined by subtracting the battery cell stack binding belt strain at full charge capacity from the battery cell stack binding belt strain at zero capacity. In some embodiments, battery cell stack binding strain at zero capacity may be inferred so that the battery does not have to go to a zero state of charge. The change in binding belt strain may be related to battery cell charge capacity loss by indexing a table or function that holds data similar to that shown in FIG. 9B.

Battery charge capacity can be determined from subtracting the cell capacity loss from the rated cell charge capacity. The battery state of health can be expressed as a percentage of battery rated capacity by dividing the battery charge capacity by the battery rated capacity.

Alternatively, battery state of health may be determined directly from change in battery cell stack binding belt strain. A present change in battery cell stack binding belt strain may be determined by subtracting the battery cell stack binding belt strain at zero state of charge from the battery cell stack binding belt strain at rated state of charge. The present change in battery cell stack binding belt strain can be divided by the change in battery cell stack binding belt strain at rated charge (battery cell stack binding belt strain at rated charge is the battery cell stack binding belt strain at rated state of charge minus battery cell stack binding belt strain at zero state of charge). The percent of battery life remaining or percent health is the present change in battery cell stack binding belt strain divided by the change in battery cell stack binding belt strain at rated battery charging capacity. After updating the battery state of health routine 1000 exits.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack system, comprising:
a plurality of battery cells;
a binding band holding said plurality of battery cells together in a group;
a strain gauge coupled to said binding band, said strain gauge providing an indication of tension of said binding band; and
a controller with instructions for estimating a state of the battery back in response to said strain gauge.

2. The system of claim 1, wherein said state includes an amount of energy stored by said plurality of battery cells, and wherein said controller further includes instructions for estimating said amount of energy stored by said plurality of battery cells from a combination of voltage measurements from said plurality of battery cells and from said strain gauge.

3. The system of claim 1, wherein said strain gauge is a piezoresistive strain gauge and wherein the state of the battery pack is a state of charge.

4. The system of claim 1 wherein said plurality of battery cells are connected by way of a bus bar.

5. The system of claim 1, further comprising a second strain gauge coupled to a second binding band, said second binding band wrapped around said plurality of battery cells.

6. The system of claim 1, wherein said binding band is wrapped around said plurality of battery cells.

7. A method for a battery pack including a plurality of battery cells bound together, comprising:
generating compression of the plurality of battery cells; and
estimating a state of the plurality of battery cells in response to an indication of the compression.

8. The method of claim 7, wherein said state is a state of charge of said plurality of battery cells, and wherein the compression is generated via a binding band binding the plurality of cells together, and wherein the indication of compression includes a signal of a strain gauge coupled to the binding band.

9. The method of claim 8, further comprising estimating a state of charge of said battery pack from a plurality of strain gauges.

10. The method of claim 8, further comprising adjusting said state of charge of said battery pack in response to a voltage reading of said plurality of battery cells.

11. The method of claim 10, wherein said voltage reading is comprised of a plurality of voltage readings of individual battery cells.

12. The method of claim 10, wherein said state of charge of said battery is based on a measured voltage for a first range of charge and on a strain gauge for a second range of charge.

13. The method of claim 7, wherein said estimate is determined in computer readable storage medium of a controller electronically or electrically coupled to the battery back, rand where the estimate is determined based on a determined amount of said compression

14. The method of claim 8, further comprising limiting charging of said plurality of battery cells when an output of said strain gauge exceeds a threshold, and wherein an output of said strain gauge is zeroed when a state of charge of said plurality of battery cells is substantially fully charged.

15. The method of claim 8, further comprising discharging said plurality of battery cells when an output of said strain gauge exceeds a threshold.

16. A method for controlling a state of charge of a battery pack, comprising:
sensing a voltage of a plurality of battery cells;
sensing an amount of compression generated within the battery pack regulating charging and discharging of said plurality of said battery cells in response to said sensed voltage and said sensed amount of compression.

17. The method of claim 16, wherein regulating said charging includes reducing an amount of current supplied to charge said plurality of battery cells.

18. The method of claim 16, wherein regulating said charging includes discharging said plurality of battery cells when a first state of charge estimate based on disagreement between said sensed amount of compression and a second state of charge estimate based on said sensed voltage.

19. The method of claim 16, further comprising performing said regulating as said plurality of battery cells are being charged or discharged at a rate above a threshold.

20. The method of claim 16, wherein current flow to said plurality of battery cells is adjusted in response to the sensed amount of compression when said sensed voltage is in a predetermined range.
